(19) United States
(12) Patent Application Publication
(10) Pub. No.: US 2014/0167407 A1
(43) Pub. Date: Jun. 19, 2014

(54) Quick Disconnect Coupler with Protective Cover

(71) Applicant: CNH America, LLC, New Holland, PA (US)

(72) Inventors: Jerry Lee Brinkley, Woodridge, IL (US); Jonathan Lewis Buelow, Woodridge, IL (US)

(73) Assignee: CNH America, LLC, New Holland, PA (US)

(21) Appl. No.: 14/022,726

(22) Filed: Sep. 10, 2013

Related U.S. Application Data
(60) Provisional application No. 61/738,136, filed on Dec. 17, 2012.

(51) Int. Cl. F16L 27/11

(52) U.S. Cl. CPC F16L 27/11
USPC 285/226

(57) ABSTRACT

A quick disconnect coupler is provided that is particularly suited for use as a case drain coupler in an agricultural work vehicle. The coupler includes a male component lockingly received within a body of a female component in a coupled state of the coupler. The female component includes an external sleeve that is linearly slidable along a slide surface of the body to engage and release the male component. A cover is engaged on the female component with a first end fixed on the body and an opposite second end fixed to the sleeve. The cover is linearly expandable with movement of the sleeve and protects the slide surface from dust or other contaminates.

### CROSS-REFERENCE TO RELATED APPLICATIONS

This application is based upon and claims priority to U.S. Provisional Application No. 61/738,136, filed on Dec. 17, 2012, the disclosure of which is hereby incorporated by reference herein in its entirety for all purposes.

### FIELD OF THE INVENTION

The present invention relates generally to mechanical coupling devices, and more particularly to a hydraulic quick disconnect coupler typically used in agricultural work vehicles for connecting hydraulic systems between a work implement and the work vehicle.

### BACKGROUND OF THE INVENTION

Quick disconnect couplers, including hydraulic and pneumatic couplers, are well known and used in numerous applications throughout various industries. For example, quick disconnect couplers are used in agricultural work vehicles, such as tractors, combines, and the like, to interface a work implement (e.g., a harvesting implement or seeder) with the vehicle's hydraulic system. In a typical configuration, the hydraulic system includes a hydraulic fluid supply line, a hydraulic fluid return line, and a case drain line that delivers leakage fluid from the implement's hydraulic motor to a fluid reservoir carried by the tractor or other vehicle (referred to collectively as a “tractor” herein). The implement generally includes hydraulic hoses fitted with quick disconnect couplers for coupling to the tractor's hydraulic system.

In a typical system, the hose for the case drain line includes a male quick connect component that interfaces with a female quick connect component on the tractor's case drain hose or directly on the case drain reservoir. The case drain line is typically a low pressure line (generally less than 25 psi) and if the connection between the male and female coupler components is not made properly, or if the connection is broken while the hydraulic motor is running, the pressure in the case drain line can build up quickly, resulting in motor damage or failure. The likelihood of motor damage is particularly acute because most work implement fan motor circuits do not provide a warning or alarm that the case drain line is disconnected or broken,

A particular problem with the conventional case drain line coupler is that the female coupler component on the tractor is located at the rear of the vehicle and is subjected to fine dust, debris, and liquid contaminates that collect and adhere to the coupler component. The female coupler typically includes a sleeve that slides linearly when connecting and disconnecting the male coupler component. The dust and other contaminates collect along the sliding path of the sleeve and prevent the female coupler from functioning properly. In particular, dust or contaminates tend to collect under the sliding sleeve and prevent the sleeve from sliding forward or backward and properly engaging the male coupler on the work implement hydraulic hose. If not properly engaged, the components will eventually disengage, resulting in damage to system components.

Efforts have been made to protect the female coupler component on the tractor, including placing removable covers, caps, or sleeves on the component, even such items as a plastic water bottle fitted onto the female coupler. These devices are, however, easily misplaced and lost when removed and, often, access is limited to install and remove the devices.

U.S. Pat. No. 5,853,200 describes a hose coupling boot for a quick disconnect coupling in the form of a conically shaped hollow tube having a stepped inner diameter profile. The boot is slid onto the male component of the coupler and includes a cylindrically extending hollow portion that extends over the female coupler in the connected state of the coupling. This type of device has the inherent drawback that it prevents visual inspection and confirmation of the coupled state of the components, and also would not prevent collection of dust and debris on the sliding surface of the female coupler component on a tractor, as discussed above.

The agricultural work vehicle industry would benefit from an improved quick disconnect coupler, particularly a coupler configuration that protects the female coupler component on a case drain line.

### BRIEF DESCRIPTION OF THE INVENTION

Aspects and advantages of the invention will be set forth in part in the following description, or may be obvious from the description, or may be learned through practice of the invention.

In accordance with aspects of the invention, a quick disconnect coupler includes a male component and a female component that lockingly engage in a coupled state of the coupler. The female component includes a body and an external sleeve that is linearly slidable along a slide surface of the body to engage and release the male component. A cover is engaged on the female component and includes a first end that is fixed on the body rearward of the slidable sleeve, and an opposite second end fixed to the sleeve. The cover has a configuration so as to be linearly expandable with movement of the sleeve relative to the body. With this unique configuration, the cover is fixed to the female component and does not need to be removed to operate the coupler. The cover does not inhibit movement of the sleeve and protects the slide surface from dust or other contaminates.

The first and second ends of the cover may be retained on the female component body by various suitable means. For example, a releasable mechanical retaining device, such as a releasable band or strap, may be used in this regard. In alternate embodiments, the ends may be adhered to the body, for example with an adhesive, epoxy, glue, or the like. In still further embodiments, the ends may be fitted into grooves or other retaining structure machined into the body.

The cover may be variously configured in accordance with different embodiments. For example, the cover may be a bellows or accordion-like member that expands and constricts with sliding movement of the sleeve relative to the body. In an alternate embodiment, the cover may be made from a generally inelastic material and have a length between its opposite ends so as to have a gathered aspect that allows for unrestrained sliding movement of the sleeve relative to the body. In still a further embodiment, the cover may be made from a generally elastic material that stretches with sliding movement of the sleeve relative to the body.

It should be appreciated that, although the coupler in accordance with aspects of the present invention has particular usefulness as a case drain coupler on an agricultural work vehicle, the couple is not limited to this use or work environment. The present invention coupler may have usefulness in any environment wherein it is desired to protect a component of a quick disconnect coupler from dirt or other contaminates.

The present invention also encompasses various embodiments of a female quick disconnect component standing alone, for example a female coupler component of an agricultural work vehicle case drain coupler. The female component may include a body mounted in fluid communication with a case drain hose or reservoir of the vehicle. The female component includes an external sleeve that is linearly slidable along a slide surface of the body to engage and release a male quick disconnect component on a hydraulic line of a work implement. A cover is engaged on the female component and includes a first end fixed on the body rearward of the sleeve, and an opposite second end fixed to the sleeve. The cover has a configuration so as to be linearly expandable with movement of the sleeve relative to the body. As mentioned above, the cover is fixed to the female component, does not inhibit movement of the sleeve, and protects the slide surface from dust or other contaminates.

Various embodiments of the female quick disconnect component may include any of the aspects discussed above and described in greater detail below. It should be understood that the present invention also encompasses any configuration of an agricultural work vehicle, such as a tractor, combine harvester, and the like, that utilizes a quick disconnect coupler as set forth herein.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a side view of a conventional agricultural tractor with attached work implement;

FIG. 2A is a side perspective view of components of a conventional quick disconnect coupler typically used in a hydraulic system;

FIG. 213 is a side perspective view of the coupler of FIG. 2A in a connected state;

FIG. 3 is a side perspective view of an embodiment of a female component of a quick disconnect coupler in accordance with aspects of the invention;

FIG. 4 is a side perspective view of an alternate embodiment of a female component of a quick disconnect coupler in accordance with aspects of the invention;

FIG. 5 is a side perspective view of the component of FIG. 4 connected to a male component of the coupler;

FIG. 6 is a side perspective view of still another embodiment of a female component of a quick disconnect coupler in accordance with aspects of the invention; and

FIG. 7 is a side perspective view of yet another embodiment of a female component of a quick disconnect coupler in accordance with aspects of the invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

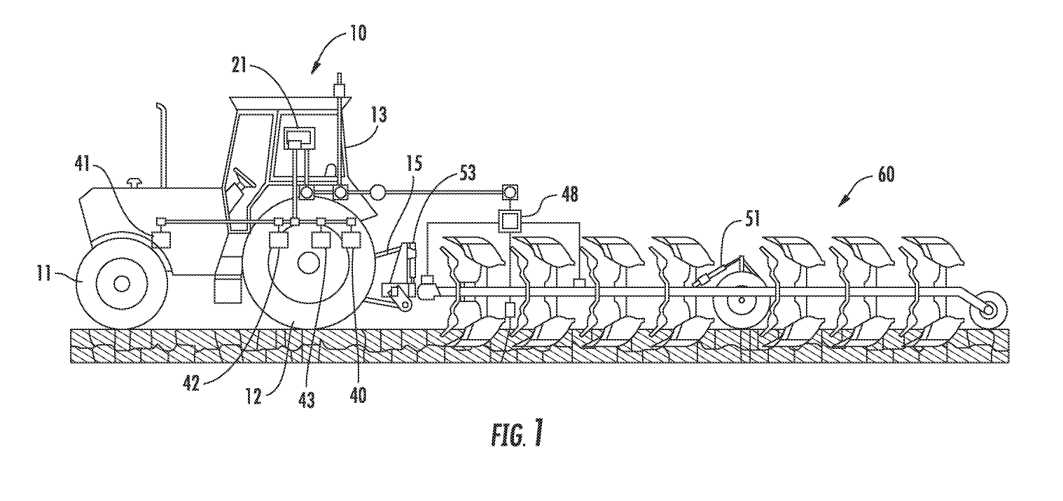

Referring to FIG. 1, a conventional agricultural work vehicle (e.g., a tractor) is denoted by the reference numeral 10. The tractor 10 includes front 11 and rear 12 pairs of driven wheels. In other well-known tractors 10, one or both pairs of driven wheels may be substituted by sets of caterpillar tracks. The tractor 10 also has an engine (not shown in the drawings), a transmission system including a gearbox, transfer box, and appropriate differentials for the driven wheels; an operator cab 13 and a three point hitch 15 at the rear of the vehicle between the rear wheels for attachment of an adjustable work implement, which in the embodiment shown is a plow 60. The tractor/implement combination 10/60 includes a plurality of slave controllers for various sub-systems, in the form of microprocessors 40, 41, 42, 43 and 48.

External hydraulics control subsystem 40 controls the flow of hydraulic fluid to actuators located externally of the tractor that draw hydraulic power from the on-board hydraulic circuit of the tractor. Certain parameters of the engine performance are controlled by means of an engine management system including microprocessor 41 that optimizes engine performance in dependence on the throttle or engine governor settings input either by the tractor operator using suitable control members indicated schematically at 21, or from a programmable controller located in the cab 13.

The tractor 10 may include a semi-automatic transmission system in which the transmission ratio selected is determined by a slave controller in the form of microprocessor 42 acting on one or more solenoids to engage and disengage gear sets of the gearbox and/or gears of the transfer box, in dependence on the settings of a plurality of gear levers in the operator's cab 13 or in dependence on signals from microprocessor 21.

The tractor 10 depicted in FIG. 1 includes a hitch microprocessor 43 and a work implement control microprocessor 48. Microprocessor 48 is operatively connected to actuators, e.g. respective hydraulic actuators 53, 51, for adjusting operational features of the work implement 60, such as the width of the plow, for inverting the plow at the end of each furrow, and for setting the plow working depth. The microprocessor 48 operates in dependence on signals received from microprocessor 21, from lever settings in cab 13, or according to its own programming.

As mentioned above, in a typical configuration between the tractor 10 and work implement 60, the hydraulic system generally consists of a hydraulic fluid supply line, a hydraulic fluid return line, and a case drain line that delivers leakage fluid from the hydraulic motor to a fluid reservoir on the tractor 10, For most fan motor circuits, the subassembly will include corresponding hydraulic hoses for the hydraulic lines that are fitted with suitable couplers for coupling the hoses to the hydraulic system of the tractor 10. In one exemplary configuration, the hose for the case drain line of the fan motor subassembly will have a male quick connect coupler that interfaces with a female quick connect coupler of the tractor's case drain hose (or fitted directly to the case drain reservoir).

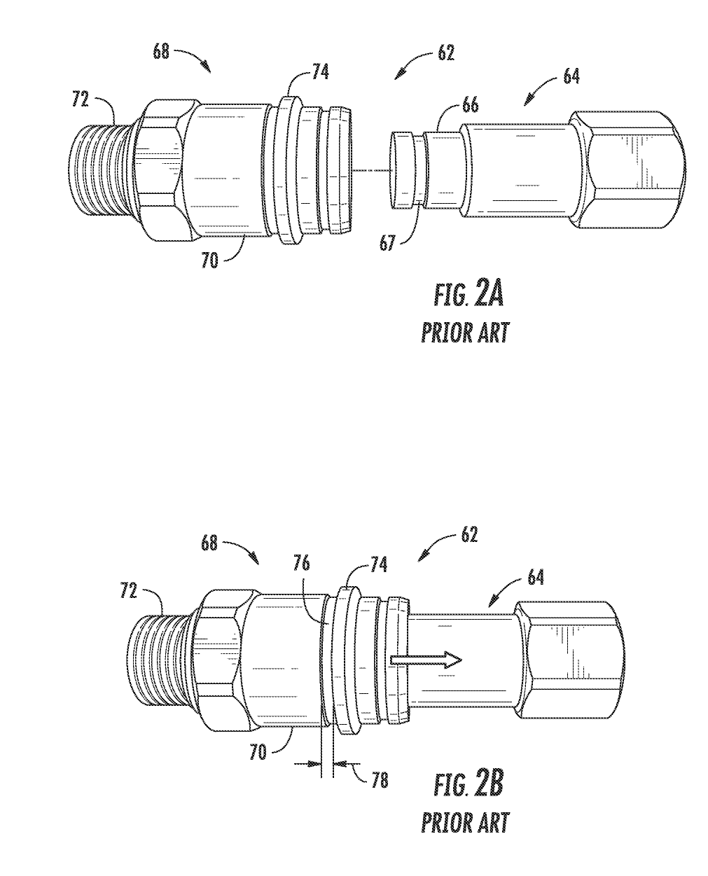

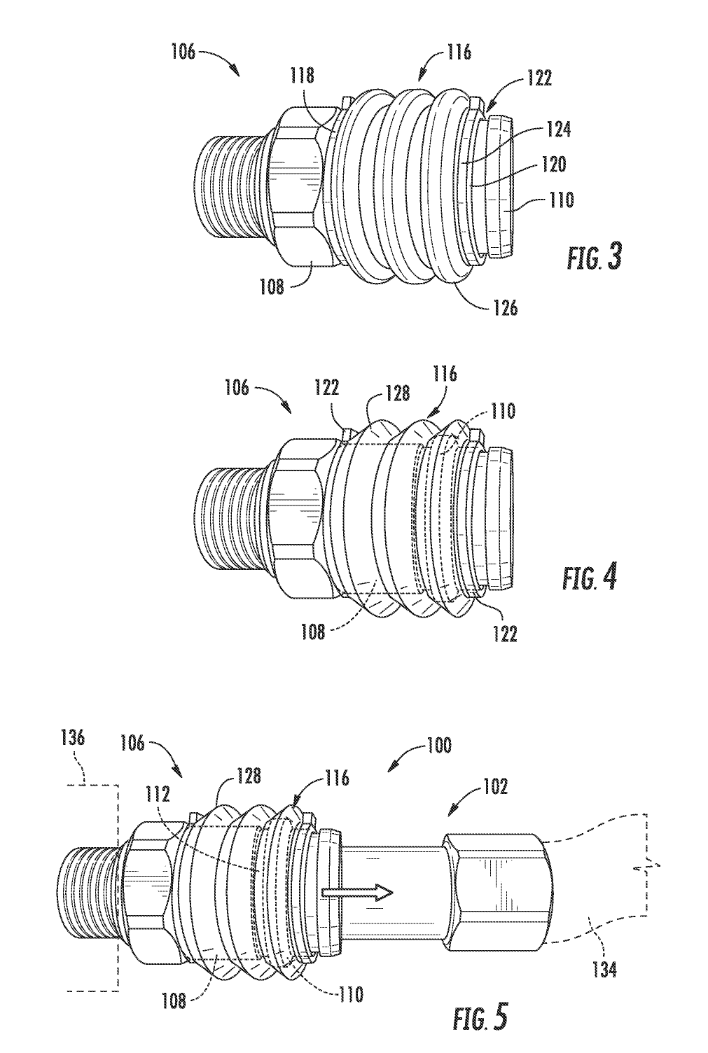

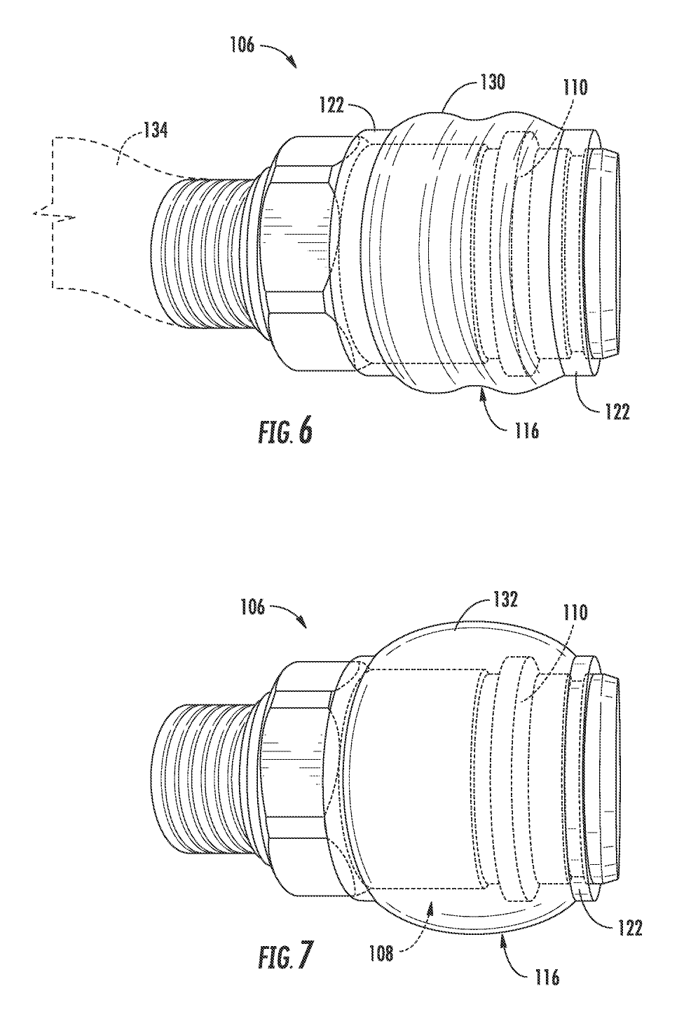

Referring now to the drawings, wherein like numbers refer to like items or features, FIGS. 2A and 2B depict a conventional prior art coupler 62 that has been used, for example, to connect a hydraulic line of an agricultural work implement 60 to an agricultural work vehicle 10, particularly to connect the case drain line to the work vehicle's case drain reservoir. The coupler 62 includes a male component 64 that is typically configured at the end of a hydraulic line. The male component 64 includes an engagement body 66 having a groove or recess 67 defined therein. The coupler 62 includes a female component 68 for receipt of the engagement body 66. An internal working mechanism is contained within the body 70 of the female component 68, such as a ball detent, or the like, for engaging within the groove 67 when the male component 64 is coupled to the female component 68, as is generally known in the art. The female component 68 may include threads 72 for directly fixing the female component 68 to a reservoir on the work vehicle 10. Alternatively, the female component 68 may include any manner of conventional fitting for attaching the component to a hydraulic line.

Referring to FIG. 2B, the female component 68 includes a sleeve 74 that is linearly slidable along a section of the body 70 when the sleeve 74 is moved in a forward position (away from thread 72), as depicted by the arrow in FIG. 2B. Movement of the sleeve 74 allows for insertion of the engagement body 66 of the male component 64 into the female component 68 and actuation of the internal retaining mechanism. The male component 64 is released from the female component 68 by movement of the sleeve to disengage the internal retaining mechanism.

Still referring to FIG. 2B, it can be appreciated that movement of the sleeve 74 exposes a sliding surface 76 on the female component body 70. This sliding surface 76 generally defines the range of movement of the sleeve 74 and has a length 78. In operation of this conventional coupler 62, the sliding surface 76 that is exposed with movement of the sleeve 74 can become covered in dirt or other contaminates, which interferes with future action of the coupler 62. For example, dirt particles that accumulate in the sliding surface 76 may prevent return movement of the sleeve 74. In addition, fine dirt particles can get under the sleeve 74 and into the internal retaining mechanism, thereby reducing the coupling action and locking ability of the internal mechanism.

Referring to FIGS. 3 through 7, various embodiments of a coupler 100 (FIG. 5) and more particularly, a female component 106, in accordance with aspects of the invention are illustrated. Referring to FIG. 3, the female component 106, which may be in accordance with the female component 68 discussed above with respect to FIGS. 2A and 2B, includes a cover 116 that is engaged on the body 108. The cover 116 includes a first end 118 that is stationarily fixed on the body 108 rearward of the sleeve 110 (FIG. 4). The cover 116 includes a second end 120 that is fixed to the sliding sleeve 110 so as to move linearly with the sleeve. The cover 116 may have various configurations and be made of various different materials to accommodate the function of moving linearly with the sleeve 110 without appreciably inhibiting movement of the sleeve 110. The cover 116 completely encloses the area of the body 108 in which the slide surface 112 (FIG. 5) is defined and, thus, prevents did or other contaminates from accumulating on the slide surface 112 or migrating under the sleeve 110 and into the internal retaining mechanism of the female component 106.

The ends of the cover 116 may be retained on the body 108 and sleeve 110 with any suitable retaining device or mechanism. For example, the retaining device 122 may be a band or strap 124, as depicted in FIG. 3, such as a conventional tie strap. The retaining mechanism 122 may be releasable so that the cover 116 may be readily replaced. In other embodiments, the ends 118, 120 of the cover 116 may be permanently adhered or otherwise fixed to the female component 106. For example, the ends may be attached with a permanent epoxy, or other adhesive material. In still further embodiments, the ends 118, 120 of the cover 116 may be fitted into grooves or slots machined into the body 108 and sleeve 110, as depicted in FIGS. 6 and 7. It should be appreciated that the invention is not limited by any particular means for securing the ends of the cover 116 relative to the body 108 and sleeve 110.

As mentioned, the cover 116 may be variously configured within the scope and spirit of the invention. In the embodiment depicted in FIG. 3, the cover 116 is a bellows member 126 that readily expands and contracts with movement of the sleeve 110. The bellows member 126 may be made of any suitable material, including a natural or synthetic material that is suitable for the working environment in which the coupler is intended. The bellows member 126 depicted in FIG. 3 is readily commercially available in various sizes and thicknesses.

FIGS. 4 and 5 depict an embodiment wherein the cover 116 is an accordion-like member 128 that includes pleats for expansion and contraction of the cover 116 with sliding movement of the sleeve 110. Again, the accordion member 128 may be formed of any suitable material plus a function of the working environment of the coupler.

FIG. 5 depicts a complete coupler 100 that includes the female coupler component 106 of FIG. 4 engaged with a male coupler component 102. The female component 106 is graphically depicted as threaded into a case drain reservoir 136, while the male component 102 is graphically illustrated as connected to a hydraulic line 134. FIG. 5 depicts sliding movement of the sleeve 110 in the direction of the male component 102, which exposes the slide surface 112. It can be readily appreciated from FIG. 5 that the slide surface 112 is completely enclosed and protected by the sleeve 116.

FIG. 6 depicts an alternative embodiment wherein the female component 106 is graphically depicted as attached to a hydraulic line 134. The cover 116 in this particular embodiment may be formed from a generally inelastic member 130. The inelastic member 130 has a sufficient length so as to have a gathered aspect in the unengaged position of the sleeve 110 illustrated in FIG. 6. The gathered aspect allows the generally inelastic member 130 to extend with movement of the sleeve 110 to the right, as discussed above with respect to FIG. 5. Again, the inelastic cover member 130 may be formed from any suitable material.

FIG. 7 depicts yet another alternative embodiment of a female coupler component 106 wherein the cover 116 is formed from a generally elastic member 132 having a formed shape, such as the slightly arcuate shape depicted in FIG. 7. The elastic member 132 has sufficient elasticity so as to accommodate sliding movement of the sleeve 110, as discussed above.

As mentioned, the present invention also includes various embodiments of a female quick disconnect component as discussed herein standing alone (i.e., without inclusion of the male coupler component). The female quick disconnect components 106 in accordance with aspects of the invention are particularly suited for agricultural work vehicle case drain couplers, as discussed above.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A quick disconnect coupler, comprising:
a male component;
a female component, said male component lockingly received within a body of said female component in a coupled state of said coupler;
said female component comprising an external sleeve that is linearly slidable along a slide surface of said body to engage and release said male component;
a cover engaged on said female component, said cover having a first end fixed on said body rearward of said sleeve, and an opposite second end fixed to said sleeve, said cover having a configuration so as to be linearly expandable with movement of said sleeve relative to said body; and
wherein said cover is fixed to said female component, does not inhibit movement of said sleeve, and protects said slide surface from dust or other contaminates.

2. The coupler as in claim 1, wherein said first and second ends of said cover are retained on said female component with a releasable mechanical retaining device.

3. The coupler as in claim 2, wherein said mechanical retaining device comprises a releasable band or strap.

4. The coupler as in claim 1, wherein either of said first or second ends of said cover is fitted into a groove or slot defined in said body of said female component.

5. The coupler as in claim 1, wherein said first and second ends of said cover are permanently adhered to said female component.

6. The coupler as in claim 1, wherein said cover comprises a bellows or accordion-like cross-sectional shape that expands and constricts with sliding movement of said sleeve relative to said body.

7. The coupler as in claim 1, wherein said cover comprises a generally inelastic material with a length so as to have a gathered aspect that allows for sliding movement of said sleeve relative to said body.

8. The coupler as in claim 1, wherein said cover comprises a generally elastic material that stretches with sliding movement of said sleeve relative to said body.

9. The coupler as in claim 1, wherein said coupler is a case drain coupler on an agricultural work vehicle.

10. A female quick disconnect component of an agricultural work vehicle case drain coupler, comprising:
a body mounted in fluid communication with a case drain hose or reservoir of the vehicle;
an external sleeve that is linearly slidable along a slide surface of said body to engage and release a male quick disconnect component;
a cover engaged on said female component, said cover having a first end fixed on said body rearward of said sleeve, and an opposite second end fixed to said sleeve, said cover having a configuration so as to be linearly expandable with movement of said sleeve relative to said body; and
wherein said cover is fixed to said female component, does not inhibit movement of said sleeve, and protects said slide surface from dust or other contaminates.

11. The female quick disconnect component as in claim 10, wherein said first and second ends of said cover are retained on said female component with a releasable mechanical retaining device.

12. The female quick disconnect component as in claim 11, wherein said mechanical retaining device comprises a releasable band or strap.

13. The female quick disconnect component as in claim 10, wherein said first and second ends of said cover are permanently adhered to said female component.

14. The female quick disconnect component as in claim 10, wherein said cover comprises a bellows or accordion-like cross-sectional shape that expands and constricts with sliding movement of said sleeve relative to said body.

15. The female quick disconnect component as in claim 10, wherein said cover comprises a generally inelastic material with a length so as to have a gathered aspect that allows for sliding movement of said sleeve relative to said body.

16. The female quick disconnect component as in claim 10, wherein said cover comprises a generally elastic material that stretches with sliding movement of said sleeve relative to said body.

17. The female quick disconnect as in claim 10, wherein either of said first or second ends of said cover is fitted into a groove or slot defined in said body.
